(19) United States
(12) Patent Application Publication
(10) Pub. No.: US 2022/0101354 A1
(43) Pub. Date: Mar. 31, 2022

(54) SHOPPER INFLUENCER SYSTEM AND METHOD

(71) Applicant: Sensormatic Electronics, LLC, Boca Raton, FL (US)

(72) Inventors: Sivaram ANNADURAI, Kudlu Gate (IN); Satyajit NAIR, Singasandra (IN); Kilton DASS, Chennai (IN)

(21) Appl. No.: 17/487,850

(22) Filed: Sep. 28, 2021

(30) Foreign Application Priority Data
Sep. 28, 2020 (IN) 202011042073

(51) Int. Cl. G06Q 30/02; G06Q 10/08; G06N 5/04; G06N 5/02; G06K 9/00

(52) U.S. Cl. CPC G06Q 30/0202; G06Q 30/0201; G06Q 10/087; G06K 9/00711; G06N 5/022; G06K 9/00335; G06N 5/04

(57) ABSTRACT

A system may be configured to perform real-time shopper influence using edge device machine learning models. In some aspects, the system may determine shopper attribute information based on one or more video frames captured by the first edge device and a first inference model of the first edge device, determine article attribute information based on one or more video frames captured by the second edge device and a second inference model of the second edge device, and identifying contextual information related to a state of the retail environment and/or historical information associated with a customer within the retail environment. Further, the system may determine, via a third inference model, real-time shopper engagement information based on the shopper attribute information, the article attribute information, and the contextual information, and transmit the real-time shopper engagement information to an employee device.

### CROSS-REFERENCE TO RELATED APPLICATION

This application claims priority to Indian Patent Application No. 202011042073, entitled “A SHOPPER INFLUENCER SYSTEM AND METHOD,” filed on Sep. 28, 2020, the disclosure of which is incorporated by reference herein in its entirety.

### BACKGROUND

In order to boost sales and prevent losing a potential customer, retail stores are required to employ techniques that can assist store associates in identifying potential customer(s). Conventionally, various approaches and techniques are deployed to provide insights about a customer's behavior. This requires collection of multiple information about customers to see which ones have one or more characteristics that classify them as a likely buyer. It is therefore necessary to understand customer's behavior to determine what makes the potential customer decide to purchase or not purchase a particular article. Knowing what influences the purchase decisions helps retailers to efficiently target customers. However, conventional techniques do not provide real-time insights that can effectively help in converting leads to sales by targeting potential customers.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure provides systems, apparatuses, and methods for real-time shopper influence using edge device machine learning (ML) models. In an aspect, a method for real-time shopper influence using edge device ML models may comprise determining, by a first edge device located within a retail environment, shopper attribute information based on one or more video frames captured by the first edge device and a first inference model of the first edge device, the shopper attribute information representing one or more attributes of a shopper at an article storage structure of a retail environment; determining, by a second edge device located within the retail environment, article attribute information based on one or more video frames captured by the second edge device and a second inference model of the second edge device, the article attribute information representing one or more attributes of an article of the article storage structure of the retail environment; identifying contextual information related to a state of the retail environment and/or historical information associated with a customer within the retail environment; determining, via a third inference model, real-time shopper engagement information based on the shopper attribute information, the article attribute information, and the contextual information; and transmitting, to an electronic device, the real-time shopper engagement information for presentation to a retail associate with a location and/or picture of the shopper.

The present disclosure includes a system having devices, components, and modules corresponding to the steps of the described methods, and a computer-readable medium (e.g., a non-transitory computer-readable medium) having instructions executable by a processor to perform the described methods. In some aspects, non-transitory computer-readable media may exclude transitory signals.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram of a shopper influencer system, according to some embodiments.

FIG. 2A is a diagram of an example training process of the shopper influencer system, according to some implementations.

FIG. 2B is a diagram of an example engagement process of the shopper influencer system, according to some implementations.

FIG. 3 illustrates an example of first edge device information, according to some implementations.

FIG. 4 illustrates an example of second edge device information, according to some implementations.

FIG. 5 is an example of a graphical user interface of a real-time engagement application, according to some implementations.

FIG. 6 is block diagram of an example of a computer device configured to implement real-time shopper influence using edge device ML models, according to some implementations.

FIG. 7 is a flow diagram of an example method of real-time shopper influence using edge device ML models, according to some implementations.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Implementations of the present disclosure provide systems, methods, and apparatuses that provide real-time shopper influence using edge device ML models. These systems, methods, and apparatuses will be described in the following detailed description and illustrated in the accompanying drawings by various modules, blocks, components, circuits, processes, algorithms, among other examples (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, among other examples, whether referred to as software, firmware, middleware, microcode, hardware description language, or otherwise.

In some implementations, one or more problems solved by the present solution is the difficulty in generating timely and accurate shopper engagement information, especially without the use of electronic tags (e.g., radio-frequency identification) and/or other wireless indicia. For example, this present disclosure describes systems and methods for employing a first edge device to capture first video information of a shopper within a retail environment and determine shopper attributes of the shopper using an edge device ML model of the first edge device, employing a second device to capture second video information of an article within the retail environment and determine article attributes of the article using an edge device ML model of the second edge device, and generating real-time shopper engagement information based on the shopper attributes and the article attributes. The shopper attributes and/or article attributes may include, but are not limited to, articles of interest of a shopper, previous visit history of a shopper, whether the shopper is a known customer, past purchase history, previously purchased articles of the shopper, dwell time interest prediction information, whether a shopper picked up an article, whether the shopper touched an article, whether the shopper used an article, whether the shopper looked at a particular article, whether the shopper gazed at a particular article, and/or whether the shopper gazed at articles similar to a particular article. In some aspects, the edge device ML models may be deep learning models configured for use on an edge device via module pruning and quantization. In some other instances, the ML models may be other types of ML models and/or pattern recognition algorithms, e.g., random forest, neural network, etc. Some examples of shopper attributes determined by the edge device ML model of the first edge device include an age or age range of the shopper, a gender of the shopper, a pose of the shopper, an emotion of the shopper, a dwell time of the shopper with reference to an article or area of the retail environment, or computing device activity by the shopper. Some examples of the article attributes determined by the edge device ML model of the second edge device include an article identifier, an article category, a count of the article, a price of the article, a brand of the article, or article purchasing information. In addition, the shopper engagement information may include a category of the shopper, an interest level of the shopper, demographic information of the shopper, article-shopper interaction information, or an alternate article recommendation. The present solution provides improved accuracy and speed for real-time shopper engagement by employing separate onsite edge devices for capturing video information and determining different types of inference information within a retail environment, and generating shopper engagement recommendations for retail associates based on the inference information. In particular, in some aspects, utilizing separate devices for capturing video information for a shopper and an article permits each edge device to be positioned suitably to capture video information for accurate attribute determination, and utilizing locally-stored edge device ML models quickly provides fresh attribute information that may be employed by a shopper engagement system while the opportunity to assist a shopper is available and the attribute information is applicable.

In some aspects, a shopper influencer system and method of the present disclosure allows retailers to understand a shopper's behavior in real time. The system and method provide insights pertaining to the shopper being either a potential shopper or a casual shopper having a lower interest in making a purchase. Based on the provided insight(s) one of the store associates can be mobilized to effectively engage with the shopper. The shopper influencer system and method of the present disclosure enable retailers to effectively convert potential leads into sales thereby boosting revenue. Still another object of the present disclosure is to provide a system and a method that focuses on reducing buying time. Yet another object of the present disclosure is to provide a system and a method that enables store employees to provide targeted promotions for low probability buyers. Still another object of the present disclosure is to provide a system and a method that enhances customers buying experience. Additionally, the shopper influencer system and method perform article level analytics to determine shopper-article interaction. The shopper-article interaction based feature captures affinity of the shopper towards to the product.

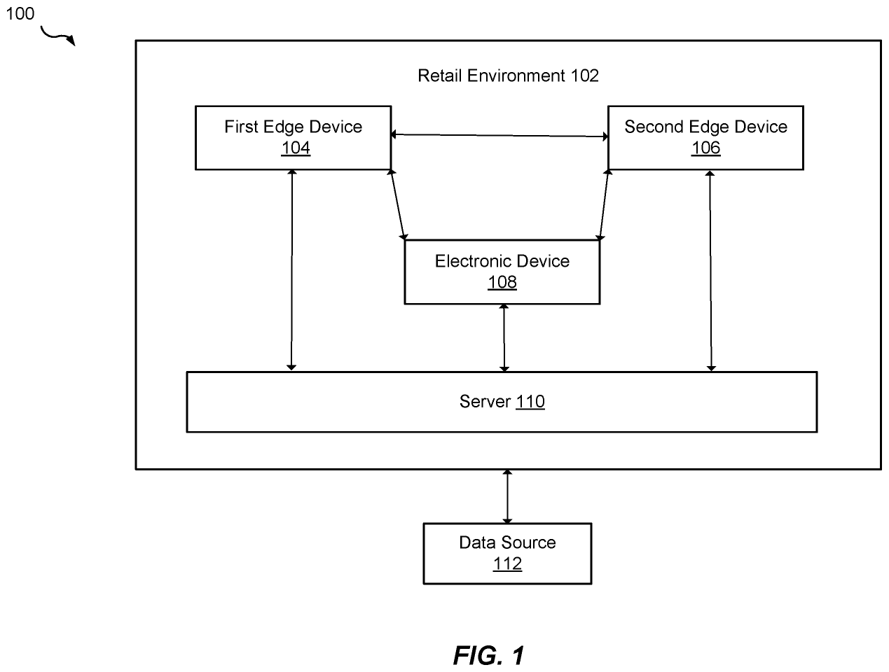

Referring now to FIG. 1, a shopper influencer system 100 is shown. The shopper influencer system 100 includes one or more first edge devices 104, one or more second edge devices 106, and one or more electronic devices 108. In an embodiment, the first edge devices 104 are typically spatially distributed within a retail environment 102. Each of the first edge device 104 is enabled to monitor behavior of the shopper to determine one or more shopper attributes. Similarly, the second edge devices 106 are deployed within the retail environment 102, and are enabled to monitor one or more articles placed on the shelf.

In an embodiment, the first edge device 104 is a camera module (not shown in the figures) having an image sensor and a processing circuit. The first edge device 104 is enabled to capture one or more images or video of the shopper(s) to determine the shopper attributes. In one embodiment, the shopper attributes can be age, gender, emotions, dwell time, mobile usage, marital status, spending capacity, etc. For example, the martial status may be inferred from a wedding ring detected within the one or more images, while the spending capacity may be determined from articles of clothing and/or other articles in possession of the shopper within the one or more images.

The processing circuit of the first edge device 104 includes one or more processors and a memory. The processor may be a general purpose or specific purpose processor, an application specific integrated circuit (ASIC), one or more field programmable gate arrays (FPGAs), a group of processing components, or other suitable processing components. The processor is configured to execute computer code or instructions stored in a memory or received from other computer readable media (e.g., CDROM, network storage, a remote server, etc.).

Memory may include one or more devices (e.g., memory units, memory devices, storage devices, etc.) for storing data and/or computer code for completing and/or facilitating the various processes described in the present disclosure. Memory may include random access memory (RAM), read-only memory (ROM), hard drive storage, temporary storage, non-volatile memory, flash memory, optical memory, or any other suitable memory for storing software objects and/or computer instructions. Memory may include database components, object code components, script components, or any other type of information structure for supporting the various activities and information structures described in the present disclosure. The memory may be communicably connected to the processor via the processing circuit and may include computer code for executing (e.g., by the processor) one or more processes described herein. When processor executes instructions stored in the memory for completing the various activities described herein, processor generally configures the processing circuit and its modules/unit to complete such activities.

In an embodiment, the second edge device 106 is also a camera module (not shown in the figures) having an image sensor and a processing circuit. The second edge device 106 is enabled to capture one or more images or video of the shelf, and is further configured to determine article attributes. In one embodiment, the article attributes can be one of, but not limited to, article category, count of articles, price of article, brand of article, etc. In one non-limiting embodiment, the second edge device 106 is also enabled to infer sale of the article. For example, the second edge device 106 may infer the sale of an article based upon the removal of the article from a shelf. Further, the second edge device 106 may infer the count of an article despite occlusion by determining an object count in a video or image frame prior to occlusion and a video or image frame after occlusion.

The processing circuit of the second edge device 106 includes one or more processors and a memory. The processor may be a general purpose or specific purpose processor, an application specific integrated circuit (ASIC), one or more field programmable gate arrays (FPGAs), a group of processing components, or other suitable processing components. The processor is configured to execute computer code or instructions stored in a memory or received from other computer readable media (e.g., CDROM, network storage, a remote server, etc.).

Memory may include one or more devices (e.g., memory units, memory devices, storage devices, etc.) for storing data and/or computer code for completing and/or facilitating the various processes described in the present disclosure. Memory may include random access memory (RAM), read-only memory (ROM), hard drive storage, temporary storage, non-volatile memory, flash memory, optical memory, or any other suitable memory for storing software objects and/or computer instructions. Memory may include database components, object code components, script components, or any other type of information structure for supporting the various activities and information structures described in the present disclosure. The memory may be communicably connected to the processor via the processing circuit and may include computer code for executing (e.g., by the processor) one or more processes described herein. When processor executes instructions stored in the memory for completing the various activities described herein, processor generally configures the processing circuit and its modules/unit to complete such activities.

In some embodiments, the first edge device 104 and the second edge device 106 are communicatively coupled by means of a wired connection or a wireless connection. The connection between the first edge device 104 and the second edge device 106 enables transfer of article attributes and/or shopper attributes between them.

In accordance with an embodiment of the present disclosure, the shopper influencer system 100 of the present disclosure further includes a server 110. The server 110 can be one of, but not limited to, a local server, a cloud server, and a remote server. For example, the server 110 can be deployed within the retail environment 102. The server 110 may be communicatively coupled with the first edge device 104, the second edge device 106, and one or more data sources 112. In an embodiment, the data source 112 can be one of, but not limited to, a weather forecast server, a social media server, news broadcasting servers, event management servers, corporate repository server, e-commerce server, and the like. In an example, the server 110 may interact with the data source 112 to fetch one of extended attributes and latent attributes, or both.

The extended attributes can be one or more of, but not limited to, week of the month, date and time, outside temperature, festive season, promotional offers, and the like. Further, the latent attributes can be one or more of, but not limited to, alternate products on sale, new launched products, weather conditions, price of the product on e-commerce platform, demand of the product, region's economic factor, and upcoming/recently launched store in the vicinity.

In one embodiment, the server 110 comprises a machine learning module that is enabled to generate a trained data derived from the extended attributes, the latent attributes, and the historical data, i.e., article attributes and shopper attributes, among others. For an example, the server 110 may periodically transmit the trained data enabling the first edge device 104 and the second edge device 106 to locally store the trained data within its memory.

In some embodiments, the first edge device 104 is enabled to provide recommendation by categorizing the shopper as potential shopper or casual shopper based on the shopper attributes, the article attributes, and the trained data. Further, the first edge device 104 is enabled to provide recommendations to one or more store associates via the electronic device 108. An application may be installed within the electronic device 108 that enables communication between the first edge device 104 and/or the second edge device 106. Further, the electronic device 108 may display recommendations provided by the first edge device 104. In an embodiment, the recommendations may include, but not limited to, category of shopper, i.e., potential or casual, interest level, shopper's demographic details, article-shopper interaction details, alternate article recommendations, and articles interested, among others. Further, the first edge device 104 may employ a classification model to determine interest level. The interest level can be one of high, medium, or low. In one embodiment, the recommendations may be accompanied with a snapshot of the shopper and his/her location within the retail store. For an example, the location within the retail store may be determined based on the article-shopper interaction details.

In one non-limiting embodiments, the recommendations may be generated and provided by the second edge device 106. In one other non-limiting embodiments, the recommendation may be provided via the electronic device 108 only for potential shoppers. However, the recommendations pertaining to the casual buyers may be computed and transmitted to the server 110 as part of the historical data. In another embodiment, the recommendations may be provided for both potential shoppers as well as casual shoppers.

In an operative configuration, the first edge device 104 is deployed in the retail environment 102, and is provided with pre-trained models to determine shopper attributes. The second edge device 106 is deployed in the retail environment 102, and is provided with pre-trained models to detect articles in the shelf and determine article attributes. The second edge device 106 classifies each shelved article to an article category along with a percentage that indicates the level of match between the identified article and the article category. Both the first edge device 104 and the second edge device 106 are synchronized in time. Further, the first edge device 104 is enabled to provide recommendations based on the shopper attribute, article attribute, and trained data. The recommendations determined by the first edge device 104 is provided to the store associate(s) via the electronic device 108, thereby enabling the retail entity to mobilize the store associate. Additionally, the shopper influencer system 100 infers sale of the article in an event when the second edge device 106 determining that the count of articles is reduced post recommendation or there is a vacant space in the shelf. In an example, the electronic device 108 is one of a computer, a desktop, a smart phone, a palmtop, a tablet, or any other portable electronic device.

In one example, the recommendations provided by the shopper influencer system 100 for interested but low potential buyers can be alternate articles from the same article category. The alternate articles can be the articles that are eligible for on-going offers. Thereby, enabling the store associates to effectively engage with the low potential buyers. In another example, the alternate articles can be recommended based on prices of the articles.

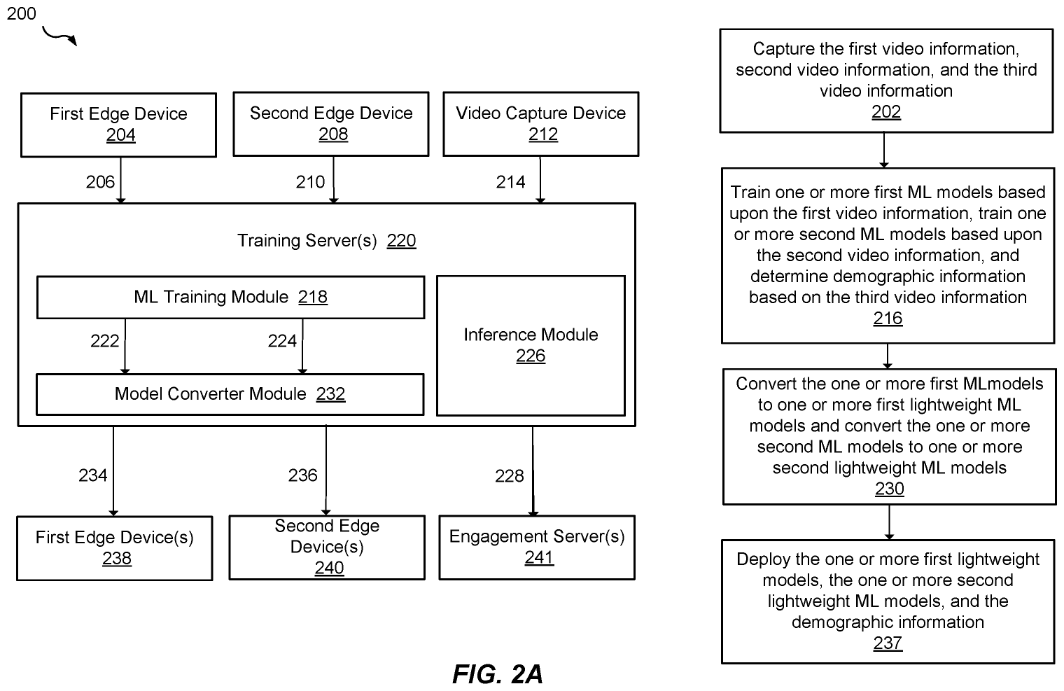

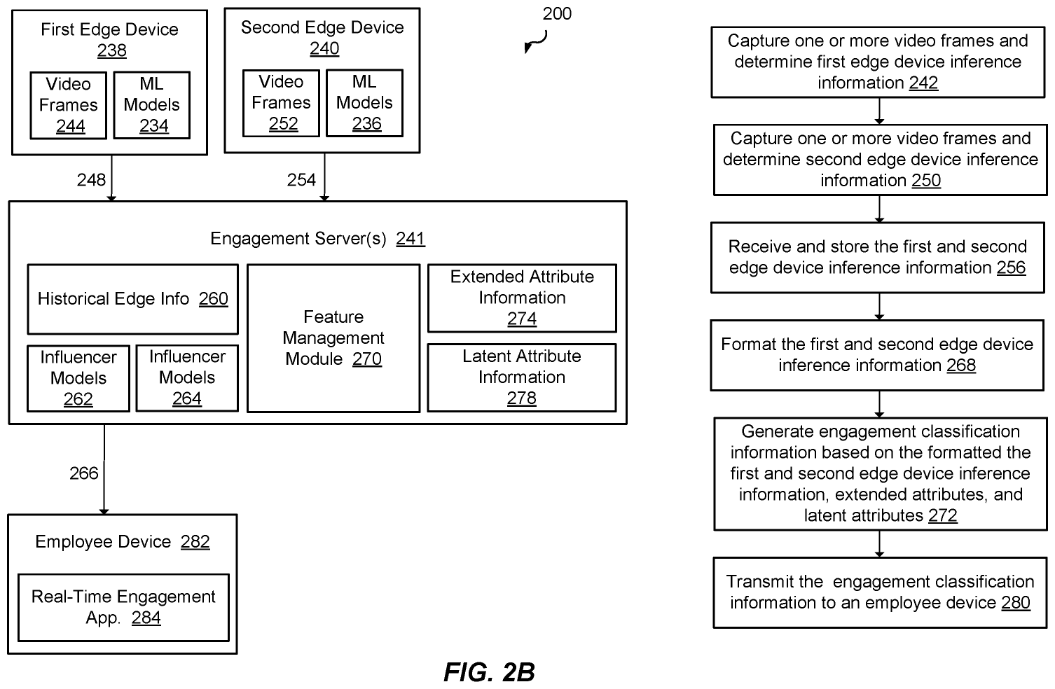

Referring now to FIGS. 2A-2B, a shopper influencer system 200 is envisaged. FIG. 2A is a flow diagram of an example training process of the shopper influencer system, according to some implementations. At block 202, a first edge device 204 (e.g., the first edge device 104) may capture first video information 206 of shopper activity within the vicinity of the one or more shelves within the retail environment, a second edge device 208 (e.g., the second edge device 106) may capture second video information 210 of shelf activity at one or more shelves within a retail environment, and a video capture device 212 may capture third video information 214 of point of sale activity within the retail environment.

At block 216, a ML training module 218 of a training device 220 may train one or more first ML models 222 based upon the first video information 206 to infer customer age, customer gender, customer pose, customer emotion, dwell time, computing device interaction (e.g., smartphone interaction), and other customer behavioral information, and train one or more second ML models 224 based upon the second video information 210 to infer an article identifier (e.g., article name), article category, count of articles, price of article, brand of article, article purchases, and other article information. Additionally, at block 216, an inference module 226 of the training device 220 may determine demographic information 228 (e.g., buyer demographics) from the third video information 214 of point of sale activity within the retail environment.

At block 230, a model converter module 232 may convert the one or more first ML models 222 to one or more first lightweight ML models 234, and the one or more second ML models 224 to one or more second lightweight ML models 236. In some aspects, the model converter module 232 may be configured to perform model pruning and/or quantization. For example, the model converter module 232 may be configured to convert a ML model into compressed representation (e.g., a compressed flat buffer), and quantize a ML model by converting 32 bit floats to 16 bit integers. As used herein, in some aspects, a lightweight model may refer to a model that can be run on an edge device in real-time. Further, a lightweight ML model may be smaller in size and require less computing power than a normal ML model.

At block 237, the one or more first lightweight ML models 234 may be deployed to one or more first edge devices 238(1)-(n) (e.g., the first edge device 104), the one or more second lightweight ML models 236 may be deployed to one or more second edge devices 240(1)-(n) (e.g., the second edge device 106), and the demographic information 228 may be deployed to an engagement server 241 (e.g., the server 110).

FIG. 2B is a flow diagram of an example engagement process of the shopper influencer system, according to some implementations. At block 242, a first edge device 238 may capture one or more video frames 244 over a first period in time, analyze the one or more video frames 244 using the one or more first lightweight ML models 234 to determine first edge device inference information 248. For example, the first edge device inference information 248 may infer behavior of a customer within a retail environment. Further, at block 250, the second edge device 240 may capture one or more video frames 252 over the same period in time, analyze the one or more video frames 252 using the one or more second lightweight ML models 236 to determine second edge device inference information 254. For example, the second edge device inference information 254 may infer activity at a shelf in the vicinity of the customer within the retail environment.

At block 256, one or more engagement servers 241 may receive the first edge device inference information 248 and the second edge device inference information 254, and store the first edge device inference information 248 and the second edge device inference information 254 as historical edge information 260. In addition, the engagement server 241 may identify one or more influencer models 262 from a plurality of influencer models 264 to employ to determine engagement classification information 266 from the first edge device inference information 248 and the second edge device inference information 254. In some aspects, the engagement server 241 may identify the one or more influencer models based on a ranking of the best performing models, and/or attributes of the shopper and/or article. Further, in some examples, the ML training module 218 and the model converter module 232 may retrain and/or update the one or more first lightweight ML models 234 and the one or more second lightweight ML models 236 using the historical edge information 260.

At block 268, a feature management module 270 may format the first edge device inference information 248 and the second edge device inference information 254. In particular, the feature management module 270 may format the first edge device inference information 248 and the second edge device inference information 254 for input into the identified influencer models 262 of the plurality of influencer models 264. As an example, the feature management module 270 may extract the features of the identified influencer models 262 from the first edge device inference information 248 and the second edge device inference information 254.

At block 272, the identified influencer models 262 may generate the engagement classification information 266 based on the formatted first edge device inference information 248, the formatted second edge device inference information 254, the extended attribute information 274, and/or the latent attribute information 278. In some examples, the engagement server 241 may employ synchronization information (time of capture data) to determine which formatted first edge device inference information 248 can be used with the formatted second edge device inference information 254 to generate the engagement classification information 266. In addition, in some examples, the engagement classification may be further determined based on historical information related to shopper collected from previous attempts to influence and/or engage with the shopper and/or previous interaction between the shopper and an article. Further, the first edge device 238 may employ a facial recognition ML model to identify the shopper. Alternatively, in some aspects, the first edge device 238 may be configured to receive the second edge device inference information 254 and determine the engagement classification information 266 as described in detail with respect to FIG. 1, or the second edge device 240 may be configured to the receive the first edge device inference information 248 and determine the engagement classification information 266 as described in detail with respect to FIG. 1

In some aspects, the engagement classification information 266 may include, but not limited to, category of shopper, i.e., potential or casual, interest level, shopper's demographic details, article-shopper interaction details, alternate article recommendations, and articles interested, among others. As described in detail herein, the engagement classification information 266 may include recommendations determined from at least the article level interactions for historical data based analytics, article-shopper level relationship, economic factors for historical data based analytics, buying time window for different genders/age groups, and associate article attributes vs shopper attributes to capture shoppers/buyers, as represented in the formatted first edge device inference information 248, the formatted second edge device inference information 254, the extended attribute information 274, and/or the latent attribute information 278.

At block 280, the engagement server 241 may transmit the engagement classification information 266 to an employee device 282 (e.g., the electronic device 108). Further, a real-time engagement application 284 on the employee device 282 may present the engagement classification information 266, a snapshot of the shopper, and his/her location within the retail environment. Some examples of the employee devices 284 include point-of-sale (POS) terminals, wearable devices (e.g., optical head-mounted display, smartwatch, etc.), smart phones and/or mobile devices, laptop and netbook computing devices, tablet computing devices, digital media devices and eBook readers, etc.

As described above, the shopper influencer system 200 includes the one or more first edge devices 238, the one or more second edge devices 240, the engagement server 241, and one or more employee devices 284. In an embodiment, the first edge devices 238 are spatially distributed within a retail environment. As described in detail herein, each of the first edge device 238 is enabled to monitor behavior of the shoppers to determine one or more shopper attributes. Similarly, the second edge devices 240 are deployed within the retail environment, and are enabled to monitor one or more articles placed on and/or within storage structures. Some examples of a storage structure include shelves, tables, display cases, showcases, etc. Further, the one or more first edge devices 238, the one or more second edge devices 240, the engagement server 241, and one or more employee devices 284 communicatively coupled by means of a wired connection or a wireless connection. The connection between the one or more first edge devices 238, the one or more second edge devices 240, the engagement server 241, and one or more employee devices 284 enables transfer of the first edge device inference information 248, the second edge device inference information 254, the contextual information determined from the extended attribute information 274 and the latent attribute information 278, and/or the engagement classification information 266 between them.

Further, the engagement process of FIG. 2B may be repeated as shoppers travel through the retail environment and interact with different articles within the retail environment. As described in detail herein, the engagement process is configured to generate the engagement classification information 266 while an employee still has time to leverage the information to interact with the shopper based on their activity with respect to the article.

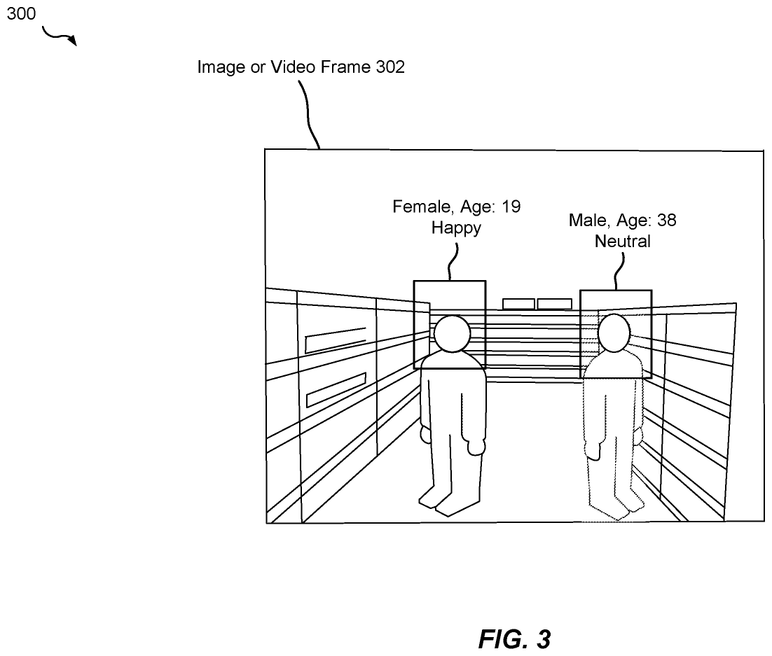

FIG. 3 is an example of first edge device inference information, according to some implementations. As illustrated in FIG. 3, the first edge device inference information 300 may include an image or video frame 302 captured by a first edge device (the first edge device 238) positioned to capture customer activity in the vicinity of a particular storage structure from a perspective that enables optimal application of the lightweight ML models 234. As illustrated in FIG. 3, the first edge device inference information 300 may include shopper attributes determined by the first edge device using the lightweight ML models 234. As an example, the shopper attributes may include at least gender, age, age group, age range, and emotion of a shopper. In addition, the first edge device inference information 300 may include a confidence value of each of the shopper attributes.

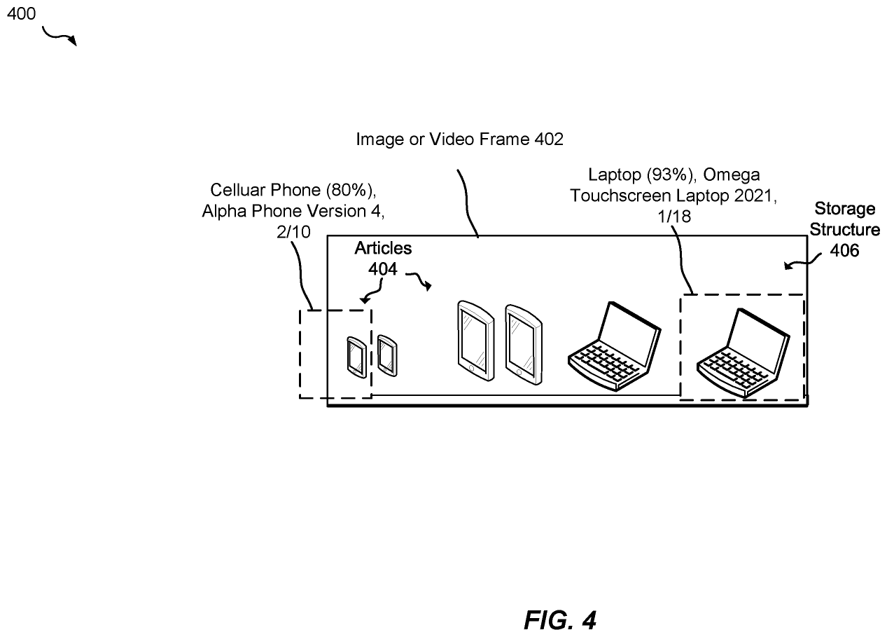

FIG. 4 is an example of second edge device inference information, according to some implementations. As illustrated in FIG. 4, the second edge device inference information 400 may include an image or video frame 402 captured by a second edge device (the second edge device 240) positioned to capture customer activity in the vicinity of one or more articles 404 and/or a particular storage structure 406 from a perspective that may enable optimal application of the lightweight ML models 236. As illustrated in FIG. 4, the second edge device inference information 400 may include article attributes determined by the second edge device using the lightweight ML models 236. As an example, the article attributes may include at least the name, model identifier, and count of an article. In addition, the second edge device inference information 400 may include a confidence value of each of the article attributes.

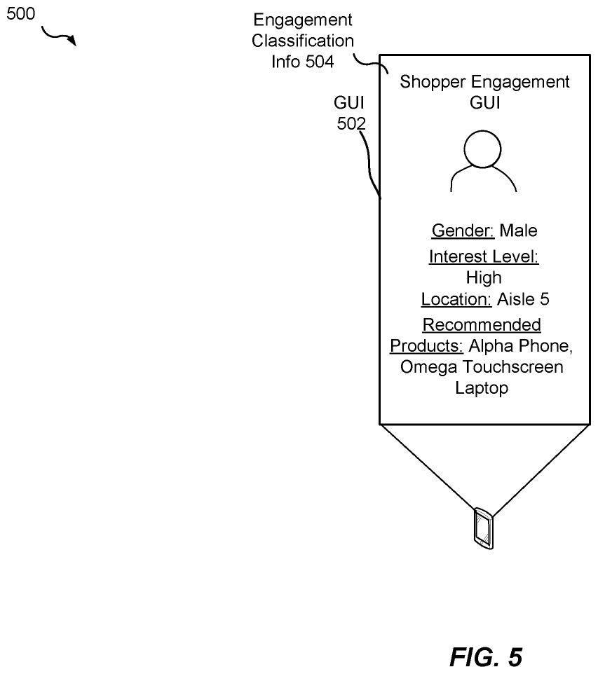

FIG. 5 is an example 500 of graphical user interface of a real-time engagement application, according to some implementations. As illustrated in FIG. 5, a graphical user interface 502 of a real-time engagement application may present engagement classification information 504 (e.g., the engagement classification information 266) to a user. As an example, the engagement classification information 504 may include at least a snapshot, gender, location interest level, and articles of interest of a shopper.

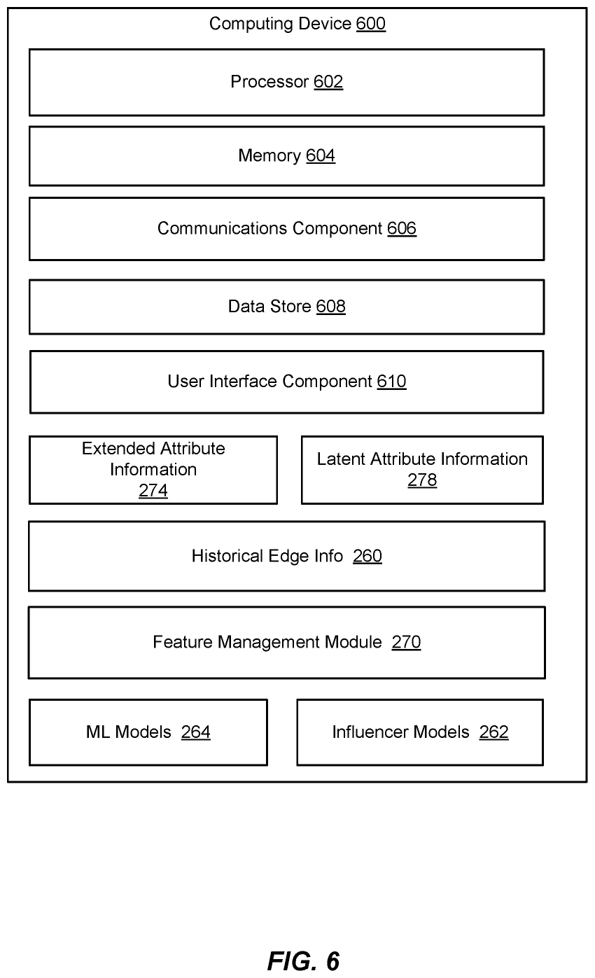

Referring to FIG. 6, a computing device 600 may implement all or a portion of the functionality described herein. The computing device 600 may be or may include or may be configured to implement the functionality of at least a portion of the shopper influencer system 100, or any component therein. For example, the computing device 600 may be or may include or may be configured to implement the functionality of the first edge device 204, the second edge device 208, the training devices 220, the plurality of first edge devices 238, the plurality of second edge devices 240, and/or the engagement servers 241. The computing device 600 includes a processor 602 which may be configured to execute or implement software, hardware, and/or firmware modules that perform any functionality described herein. For example, the processor 602 may be configured to execute or implement software, hardware, and/or firmware modules that perform any functionality described herein with reference to the ML training module 218, the inference module 226, the model converter module 232, the feature management module 270, or any other component/system/device described herein.

The processor 602 may be a micro-controller, an application-specific integrated circuit

(ASIC), a digital signal processor (DSP), or a field-programmable gate array (FPGA), and/or may include a single or multiple set of processors or multi-core processors. Moreover, the processor 602 may be implemented as an integrated processing system and/or a distributed processing system. The computing device 600 may further include a memory 604, such as for storing local versions of applications being executed by the processor 602, related instructions, parameters, etc. The memory 604 may include a type of memory usable by a computer, such as random access memory (RAM), read only memory (ROM), tapes, magnetic discs, optical discs, volatile memory, non-volatile memory, and any combination thereof. Additionally, the processor 602 and the memory 604 may include and execute an operating system executing on the processor 602, one or more applications, display drivers, etc., and/or other components of the computing device 600.

Further, the computing device 600 may include a communications component 606 that provides for establishing and maintaining communications with one or more other devices, parties, entities, etc. utilizing hardware, software, and services. The communications component 606 may carry communications between components on the computing device 600, as well as between the computing device 600 and external devices, such as devices located across a communications network and/or devices serially or locally connected to the computing device 600. In an aspect, for example, the communications component 606 may include one or more buses, and may further include transmit chain components and receive chain components associated with a wireless or wired transmitter and receiver, respectively, operable for interfacing with external devices.

Additionally, the computing device 600 may include a data store 608, which can be any suitable combination of hardware and/or software, that provides for mass storage of information, databases, and programs. For example, the data store 608 may be or may include a data repository for applications and/or related parameters not currently being executed by processor 602, e.g., the historical edge information 260, the influencer models 262, the extended attribute information 274, and/or the latent attribute information 278. In addition, the data store 608 may be a data repository for an operating system, application, display driver, etc., executing on the processor 602, and/or one or more other components of the computing device 600.

The computing device 600 may also include a user interface component 610 operable to receive inputs from a user of the computing device 600 and further operable to generate outputs for presentation to the user (e.g., via a display interface to a display device). The user interface component 610 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 610 may include one or more output devices, including but not limited to a display interface, a speaker, a haptic feedback mechanism, a printer, any other mechanism capable of presenting an output to a user, or any combination thereof.

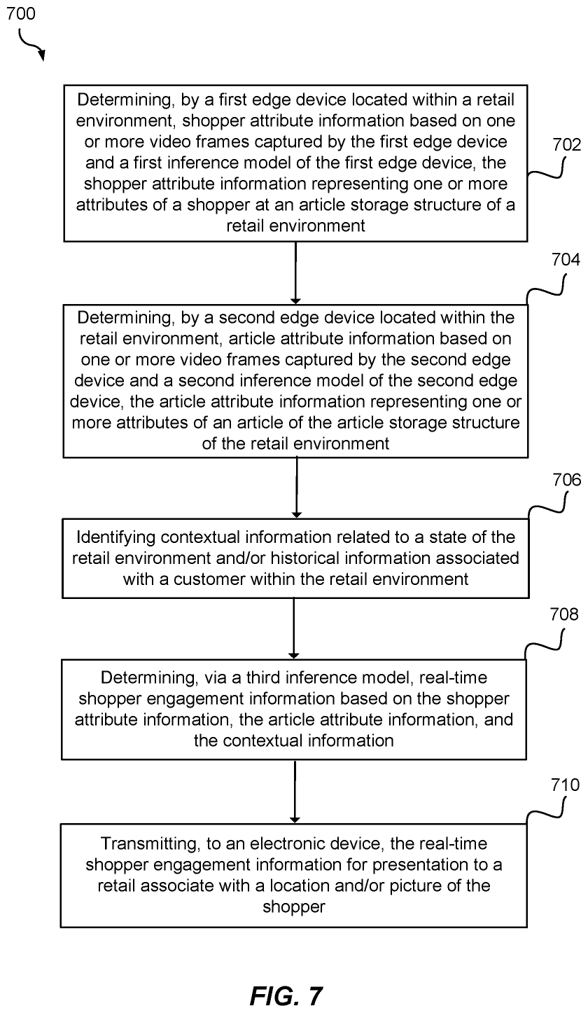

Referring to FIG. 7, in operation, the engagement server 241 or computing device 600 may perform an example method 700 for real-time shopper influence using edge device ML models. The method 700 may be performed by one or more components of the first edge device, the second edge device, the electronic device 108, the server 110, the first edge device 204, the second edge device 208, the video capture device 212, the training device 220, the first edge devices 238, the second edge devices 240, the engagement servers 241, the employee device 282, the computing device 600, or any device/component described herein according to the techniques described with reference to FIGS. 1-6.

At block 702, the method 700 includes determining, by a first edge device located within a retail environment, shopper attribute information based on one or more video frames captured by the first edge device and a first inference model of the first edge device, the shopper attribute information representing one or more attributes of a shopper at an article storage structure of a retail environment. For example, the first edge device 204 may determine the first edge device inference information 248 based on the one or more first lightweight ML models 234 and the one or more video frames 244. In some aspects, the first edge device inference information 248 may include, but is not limited to, articles of interest to the shopper, previous visit history of the shopper, whether the shopper is a known customer, past purchase history, previously purchased articles, dwell time interest prediction information, whether a shopper picked up an article, whether the shopper touched an article, whether the shopper used an article, whether the shopper looked at a particular article, whether the shopper gazed at a particular article, and/or whether the shopper gazed at articles similar to a particular article. Accordingly, the first edge device 104, the first edge devices 238, the computing device 600, and/or the processor 602 may provide means for determining, by a first edge device located within a retail environment, shopper attribute information based on one or more video frames captured by the first edge device and a first inference model of the first edge device, the shopper attribute information representing one or more attributes of a shopper at an article storage structure of a retail environment.

At block 704, the method 700 includes determining, by a second edge device located within the retail environment, article attribute information based on one or more video frames captured by the second edge device and a second inference model of the second edge device, the article attribute information representing one or more attributes of an article of the article storage structure of the retail environment. For example, the second edge device 208 may determine the second edge device inference information 254 based on the one or more second lightweight ML models 236 and the one or more video frames 252. Accordingly, the second edge device 106, the second edge devices 240, the computing device 600, and/or the processor 602 may provide means for determining, by a second edge device located within the retail environment, article attribute information based on one or more video frames captured by the second edge device and a second inference model of the second edge device, the article attribute information representing one or more attributes of an article of the article storage structure of the retail environment.

At block 706, the method 700 includes identifying contextual information related to a state of the retail environment and/or historical information associated with a customer within the retail environment. For example, the engagement server 241 may determine contextual information based on the extended attribute information 274 and the latent attribute information 278 associated with the retail environment where the first edge device 238 and the second edge device 240 are located. Accordingly, the server 110, the engagement server 241, the computing device 600, and/or the processor 602 may provide means for identifying contextual information related to a state of the retail environment and/or historical information associated with a customer within the retail environment.

At block 708, the method 700 includes determining, via a third inference model, real-time shopper engagement information based on the shopper attribute information, the article attribute information, and the contextual information. For example, the engagement server 241 may generate the engagement classification information 266 based on the first edge device inference information 248, the second edge device inference information 254, and the contextual information determined from the extended attribute information 274 and the latent attribute information 278. Accordingly, the server 110, the engagement server 241, the computing device 600, and/or the processor 602 may provide means for determining, via a third inference model, real-time shopper engagement information based on the shopper attribute information, the article attribute information, and the contextual information.

At block 710, the method 700 includes transmitting, to an electronic device, the real-time shopper engagement information for presentation to a retail associate with a location and/or picture of the shopper. For example, the engagement server 241 may transmit the engagement classification information 266 to the employee device 282. Accordingly, the server 110, the engagement server 241, the computing device 600, and/or the processor 602 may provide means for transmitting, to an electronic device, the real-time shopper engagement information for presentation to a retail associate with a location and/or picture of the shopper.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method comprising:
determining, by a first edge device located within a retail environment, shopper attribute information based on one or more video frames captured by the first edge device and a first inference model of the first edge device, the shopper attribute information representing one or more attributes of a shopper at an article storage structure of the retail environment;
determining, by a second edge device located within the retail environment, article attribute information based on one or more video frames captured by the second edge device and a second inference model of the second edge device, the article attribute information representing one or more attributes of an article of the article storage structure of the retail environment;
identifying contextual information related to a state of the retail environment and/or historical information associated with a customer within the retail environment;
determining, via a third inference model, real-time shopper engagement information based on the shopper attribute information, the article attribute information, and the contextual information; and
transmitting, to an electronic device, the real-time shopper engagement information for presentation to a retail associate with a location and/or picture of the shopper.

2. The method of claim 1, further comprising:
generating a fourth inference model based on a plurality of video information capturing shopper activity and/or shopper behavior;
converting the fourth inference model to the first inference model, the converting configuring the first inference model for use at the first edge device; and
deploying the first inference model to the first edge device.

3. The method of claim 1, further comprising:
generating a fourth inference model based on a plurality of video information capturing article attributes and activity;
converting the fourth inference model to the second inference model, the converting configuring the first inference model for use at the second edge device; and
deploying the second inference model to the second edge device.

4. The method of claim 1, wherein the shopper attribute information includes at least one of an age, a gender, a pose, an emotion, a dwell time, marital status, spending capacity, or computing device interaction.

5. The method of claim 1, wherein the article attribute information includes at least one of an article identifier, an article category, a count of the article, a price of the article, a brand of the article, or purchase information.

6. The method of claim 1, wherein the real-time shopper engagement information includes at least one a category of shopper, an interest level, demographic information, article-shopper interaction information, or an alternate article recommendation.

7. The method of claim 1, wherein identifying the contextual information comprises determining a week of a month, a date and time, an outside temperature, a festive season, a promotional offer, an article on sale, a newly launched article, economic conditions, or article demand.

8. A system within a retail environment, comprising:
a first edge device configured to determine shopper attribute information of a shopper based on one or more video frames captured by the first edge device and a first inference model;
a second edge device configured to determine article attribute information of an article based on one or more video frames captured by the second edge device and a second inference model of the second edge device; and
a server device comprising:
a memory storing instructions thereon; and
at least one processor coupled with the memory and configured by the instructions to:
receive, via a communications network, the shopper attribute information and the article attribute information;
identify contextual information related to a state of the retail environment and/or historical information associated with a customer within the retail environment;
determine, via a third inference model, real-time shopper engagement information based on the shopper attribute information, the article attribute information, and the contextual information; and
transmit, to an electronic device, the real-time shopper engagement information for presentation to a retail associate with a location and/or picture of the shopper.

9. The system of claim 8, wherein the at least one processor is further configured by the instructions to:
generate a fourth inference model based on a plurality of video information capturing shopper activity and/or shopper behavior;
convert the fourth inference model to the first inference model, the converting configuring the first inference model for use at the first edge device; and
deploying the first inference model to the first edge device.

10. The system of claim 8, wherein the at least one processor is further configured by the instructions to:
generate a fourth inference model based on a plurality of video information capturing article attributes and activity;
convert the fourth inference model to the second inference model, the converting configuring the first inference model for use at the second edge device; and
deploy the second inference model to the second edge device.

11. The system of claim 8, wherein the shopper attribute information includes at least one of an age, a gender, a pose, an emotion, a dwell time, or computing device interaction.

12. The system of claim 8, wherein the article attribute information includes at least one of an article identifier, an article category, a count of the article, a price of the article, a brand of the article, or purchase information.

13. The system of claim 8, wherein the real-time shopper engagement information includes at least one a category of shopper, an interest level, demographic information, article-shopper interaction information, or an alternate article recommendation.

14. The system of claim 8, wherein identifying the contextual information comprises determining a week of a month, a date and time, an outside temperature, a festive season, a promotional offer, an article on sale, a newly launched article, economic conditions, or article demand.

15. A non-transitory computer-readable device having instructions thereon that, when executed by at least one computing device, causes the at least one computing device to perform operations comprising:
determining, by a first edge device located within a retail environment, shopper attribute information based on one or more video frames captured by the first edge device and a first inference model of the first edge device, the shopper attribute information representing one or more attributes of a shopper at an article storage structure of a retail environment;
determining, by a second edge device located within the retail environment, article attribute information based on one or more video frames captured by the second edge device and a second inference model of the second edge device, the article attribute information representing one or more attributes of an article of the article storage structure of the retail environment;
identifying contextual information related to a state of the retail environment and/or historical information associated with a customer within the retail environment;
determining, via a third inference model, real-time shopper engagement information based on the shopper attribute information, the article attribute information, and the contextual information; and
transmitting, to an electronic device, the real-time shopper engagement information for presentation to a retail associate with a location and/or picture of the shopper.

16. The non-transitory computer-readable device of claim 15, wherein the operations further comprise:
generating a fourth inference model based on a plurality of video information capturing shopper activity and/or shopper behavior;
converting the fourth inference model to the first inference model, the converting configuring the first inference model for use at the first edge device; and
deploying the first inference model to the first edge device.

17. The non-transitory computer-readable device of claim 15, wherein the operations further comprise:
generating a fourth inference model based on a plurality of video information capturing article attributes and activity;
converting the fourth inference model to the second inference model, the converting configuring the first inference model for use at the second edge device; and
deploying the second inference model to the second edge device.

18. The non-transitory computer-readable device of claim 15, wherein the shopper attribute information includes at least one of an age, a gender, a pose, an emotion, a dwell time, marital status, spending capacity, or computing device interaction.

19. The non-transitory computer-readable device of claim 15, wherein the article attribute information includes at least one of an article identifier, an article category, a count of the article, a price of the article, a brand of the article, or purchase information.

20. The non-transitory computer-readable device of claim 15, wherein the shopper engagement information includes at least one a category of shopper, an interest level, demographic information, article-shopper interaction information, or an alternate article recommendation.
